(19) United States
(12) Patent Application Publication
(10) Pub. No.: US 2015/0051067 A1
(43) Pub. Date: Feb. 19, 2015

(54) Oxygen storage material without rare earth metals

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 13/970,172

(22) Filed: Aug. 19, 2013

(51) Int. Cl. B01J 23/889; B01J 23/20

(52) U.S. Cl. CPC B01J 23/8892; B01J 23/20
USPC 502/324; 502/349

(57) ABSTRACT

The present disclosure relates to an enhanced oxygen storage material (OSM) that may be converted into powder form and used as a raw material for a vast number of applications, and more particularly in catalyst systems. The disclosed OSM, substantially free from PGM and rare earth (RE) metals, has significantly higher oxygen storage capacity (OSC) than conventional OSM including PGM and RE metals. The disclosed OSM may be converted into powder, including a formulation of Cu—Mn spinel structure deposited on Nb—Zr oxide support. The disclosed OSM may also be coated onto a ceramic substrate as washcoat layer for characterization under OSC isothermal oscillating condition. The disclosed OSM may have an optimal OSC property that increases with the temperature, showing acceptable level of O₂ storage even at low temperatures.

### CROSS-REFERENCE TO RELATED APPLICATIONS

N/A

### BACKGROUND

1. Field of the Disclosure

This disclosure relates generally to oxygen storage materials having high oxygen storage capacity with different applications and, more particularly in catalyst systems.

2. Background Information

Catalysts are required to remove by chemical reaction the main pollutants of carbon monoxide (CO), unburnt hydrocarbons (HC) and nitrogen oxides (NOx) from internal combustion engines exhaust gases. The gases of an internal combustion engine exhaust vary from reducing conditions (rich conditions) to oxidizing conditions (lean conditions). Under rich conditions the oxygen required to oxidize the CO and HC components may be provided by an oxygen storage material (OSM) included in the catalyst system. When the system changes to lean conditions the OSM is oxidized by the gases so that it can again provide oxygen when rich conditions are encountered.

Three-way catalysts (TWC), including platinum group metals (PGM) as active sites, alumina-based supports with a large specific surface, and, metal oxide promoter materials that regulate oxygen storage properties, are placed in the exhaust gas line of internal combustion engines for the control of NOx, CO, and HC emissions. TWCs operate under atmospheres with fluctuating air to fuel ratios (A/F) in order to maintain the average A/F close to stoichiometry.

OSM included in a catalyst system is needed for storing excess oxygen in an oxidizing atmosphere and releasing it in a reducing atmosphere. Through oxygen storage and release, a safeguard is obtained against fluctuations in exhaust gas composition during engine operation, enabling the system to maintain a stoichiometric atmosphere in which NOx, CO and HC can be converted efficiently. Ceria (CeO₂) was the first material used as OSM in catalyst systems because of its effective oxygen storage capacity (OSC) properties. Subsequently, a CeO₂—ZrO₂ solid solution replaced ceria because of its improved OSC and thermal stability.

With the ever stricter standards for acceptable emissions, the demand on PGM continues to increase due to their efficiency in removing pollutants from exhaust. However, the demand for PGM and rare earth (RE) metals, places a strain on the supply of PGM and rare earth (RE) metals, which in turn drives up their cost and therefore the cost of catalysts applications.

For the foregoing reasons, there is a need for an enhanced material which may have optimal OSC property while maintaining upon the thermal stability and facile nature of the redox function of the used chemical components, without PGM and RE metals, and up to the theoretical limit in real catalysts.

### SUMMARY

The present disclosure may provide enhanced oxygen storage materials which may exhibit optimal oxygen storage capacity property, enhanced thermal stability and facile nature of the redox function of the included chemical components. The OSM disclosed may be prepared using a suitable synthesis method to use as coating layer on substrate or to form powder, which may be employed as raw material for a large number of applications, and, more particularly, for catalyst systems. The disclosed OSM may include a chemical composition that is substantially free from PGM and RE metals.

According to an embodiment in the present disclosure, the disclosed OSM may include a Cu—Mn spinel phase with Niobium-Zirconia support oxide, where the material may be dried and calcined at about 600° C. to form spinel structure.

The OSC property of the disclosed OSM, according to other embodiments in the present disclosure, may be determined using CO and O₂ pulses under isothermal oscillating condition, referred as OSC test, to determine O₂ and CO delay times. To compare performance of the disclosed OSM with PGM catalysts, fresh and hydrothermally aged samples of the disclosed OSM and a commercial PGM catalyst samples including conventional Ce-based OSMs may be subjected to isothermal OSC test.

According to principles in the present disclosure, OSC property of the disclosed OSM may be provided at a plurality of temperatures within a range of about 100° C. to about 600° C. under oscillating condition to show temperature dependency of OSC property.

It may be found from the present disclosure that although the catalytic activity, and thermal and chemical stability of a catalyst during real use may be affected by factors, such as the chemical composition of the catalyst, the OSC property of the disclosed OSM may provide an indication that for catalyst applications, and, more particularly, for catalyst systems, the chemical composition of the OSM, free of PGM and RE metals, may be more efficient operationally-wise, and from a catalyst manufacturer's viewpoint, an essential advantage given the economic factors involved.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows OSC isothermal oscillating test results for a fresh sample of the disclosed OSM at 575° C., according to an embodiment.

FIG. 2 depicts a graph carbon balance obtained during OSC isothermal oscillating test of a fresh sample of the disclosed OSM, according to an embodiment.

FIG. 3 illustrates OSC isothermal oscillating test results for disclosed OSM after aging, according to an embodiment.

FIG. 4 shows OSC isothermal oscillating test for a fresh sample of a commercial PGM catalyst including Ce-based OSM, according to an embodiment.

FIG. 5 depicts OSC property of fresh sample of the disclosed OSM with variation of temperature, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Rare earth (RE) metals” refers to chemical elements in the lanthanides group, scandium, and yttrium.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Milling” refers to the operation of breaking a solid material into a desired grain or particle size.

“Co-precipitation” may refer to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean and to release it at rich condition.

“Conversion” refers to the chemical alteration of at least one material into one or more other materials.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

### DESCRIPTION OF THE DRAWINGS

The present disclosure may generally provide an oxygen storage material (OSM), without PGM and RE metals, having an enhanced oxygen storage capacity (OSC) and thermal stability, incorporating more active components into phase materials possessing properties, such as improved oxygen mobility, to enhance the catalytic activity of the catalyst system in which the disclosed OSM may be employed.

OSM Material Composition and Preparation

The OSM disclosed may include a chemical composition that is substantially free from PGM and RE metals to prepare an OSM powder which may be used as a raw material for a large number of catalyst applications, and, more particularly, in TWC systems. The powder may be prepared from a Cu—Mn stoichiometric spinel structure, CuMn₂O₄, supported on Nb₂O₅—ZrO₂ by using co-precipitation method or any other preparation technique known in the art.

The preparation of OSM may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing, from about 1 to 2 hours, the appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, for which an appropriate amount of one or more of sodium hydroxide (NaOH) solution, sodium carbonate (Na₂CO₃) solution, ammonium hydroxide (NH₄OH) solution, tetraethyl ammonium hydroxide (TEAH) solution and other suitable base solutions may be added to the Cu—Mn/Nb₂O₅—ZrO₂ slurry. For the precipitation process, the pH of the Cu—Mn/Nb₂O₅—ZrO₂ slurry may be adjusted at the range of about 7-9 using suitable base solution by adding appropriate amount of base solution. The precipitated slurry may be aged for a period of time of about 12 to 24 hours under continued stirring at room temperature.

For preparation of powder OSM, after precipitation step, the slurry may undergo filtering and washing, where the resulting material may be dried overnight at about 120° C. and subsequently calcined at a suitable temperature within a range of about 550° C. to about 650° C., preferably at about 600° C. for about 5 hours. The prepared powder of disclosed OSM, according to principles in the present disclosure, may be used for a variety of catalyst system applications, particularly TWC systems.

According to principles in the present disclosure, OSM may be used as coating layer on substrate, using a cordierite material with honeycomb structure, where substrate may have a plurality of channels with suitable porosity. The OSM in form of aqueous slurry of Cu—Mn/Nb₂O₅—ZrO2 may be deposited on the suitable substrate to form a washcoat (WC) employing vacuum dosing and coating systems. In the present disclosure, a plurality of capacities of WC loadings may be coated on the suitable substrate. The plurality of WC loading may vary from about 60 g/L to about 200 g/L, in this disclosure particularly about 120 g/L. Subsequently, after deposition on substrate of the suitable loadings of Cu—Mn/Nb₂O₅—ZrO2 OSM slurry, the washcoat may be treated.

According to embodiments in the present disclosure, treatment of the WC may be enabled employing suitable drying and heating processes. A commercially-available air knife drying systems may be employed for drying the WC. Heat treatments may be performed using commercially-available firing (calcination) systems. The treatment may take from about 2 hours to about 6 hours, preferably about 4 hours, at a temperature within a range of about 550° C. to about 650° C., preferably at about 600° C.

A suitable OSM deposited on substrate may have a chemical composition with a total loading of about 120 g/L, including a Cu—Mn spinel structure with copper loading of about 10 g/L to about 15 g/L and manganese loading of about 20 g/L to about 25 g/L. The Nb₂O₅—ZrO₂ support oxide may have loadings of about 80 g/L to about 90 g/L.

According to principles in the present disclosure, the disclosed OSM system may be subjected to testing under OSC isothermal oscillating condition to determine the O₂ and CO delay times and OSC property at a selected temperature. A set of different O₂ and CO delay times may be obtained when a range of temperatures may be chosen to further characterize the OSC property of the OSM material. The OSC property obtained from testing may be used to compare the results with a PGM catalyst including Ce-based OSM. In order to check the thermal stability of the disclosed OSM system, which is free of PGM and RE metals, samples may be hydrothermally aged employing about 10% steam/air at about 900° C. for about 4 hours and results compared with a plurality of fresh samples.

OSC Isothermal Oscillating Test Procedure

Testing of the OSC property of the disclosed OSM may be performed under isothermal oscillating condition to determine O₂ and CO delay times, the time required to reach to 50% of the O₂ and CO concentration in feed signal. Testing may be performed for fresh and hydrothermally aged samples of the disclosed OSM and for PGM catalyst samples to compare performance of the disclosed OSM.

The OSC isothermal test may be carried out at temperature of about 575° C. with a feed of either O₂ with a concentration of about 4,000 ppm diluted in inert nitrogen (N₂), or CO with a concentration of about 8,000 ppm of CO diluted in inert N₂. The OSC isothermal oscillating test may be performed in a quartz reactor using a space velocity (SV) of 60,000 hr-1, ramping from room temperature to isothermal temperature of about 575° C. under dry N₂. At the temperature of about 575° C., OSC test may be initiated by flowing O₂ through the OSM sample in the reactor, and after 2 minutes, the feed flow may be switched to CO to flow through the OSM sample in the reactor for another 2 minutes, enabling the isothermal oscillating condition between CO and O₂ flows during a total time of about 1,000 seconds. Additionally, O₂ and CO may be allowed to flow in the empty test reactor not including the disclosed OSM. Subsequently, testing may be performed allowing O₂ and CO to flow in the test tube reactor including a fresh sample of the disclosed OSM and observe/measure the OSC property of the disclosed OSM. As the disclosed OSM may have OSC property, the OSM may store O₂ when O₂ flows. Subsequently, when CO may flow, there is no O₂ flowing, and the O₂ stored in the disclosed OSM may react with the CO to form CO₂. The time during which the OSM may store O₂ and the time during which CO may be oxidized to form CO₂ may be measured.

According to principles in the present disclosure, the OSC test may assist in analyzing/measuring an elemental carbon balance and illustrate what occurs during flowing of CO through the OSM sample, the desorption of O₂ which may be stored in the disclosed OSM, and the formation of CO₂ in absence of a O₂ stream.

OSC Property of a Fresh OSM Sample

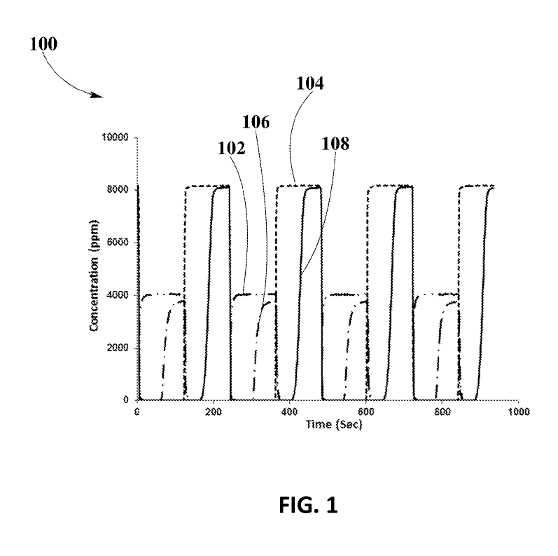

FIG. 1 shows OSC isothermal oscillating test 100 for a fresh sample of OSM at temperature of about 575° C., according to an embodiment. In FIG. 1, curve 102 (double-dot dashed graph) shows the result of flowing 4,000 ppm O₂ through an empty test reactor which may be used for OSC isothermal oscillating test 100; curve 104 (dashed graph) depicts the result of flowing 8,000 ppm CO through the empty test reactor; curve 106 (single-dot dashed graph) shows the result of flowing 4,000 ppm O₂ through the test reactor including the disclosed OSM; and curve 108 (solid line graph) depicts the result of flowing 8,000 ppm CO through the test reactor including the disclosed OSM.

It may be observed in FIG. 1 that the O₂ signal in presence of the disclosed OSM, as shown in curve 106, does not reach the O₂ signal of empty reactor shown in curve 102. This result indicates the storage of a large amount of O₂ in the disclosed OSM sample. The measured O₂ delay time, which is the time required to reach to an O₂ concentration of 2,000 ppm (50% of feed signal) in presence of the OSM sample, is about 62.99 seconds. The O₂ delay time measured from OSC isothermal oscillating test 100 indicates that the disclosed OSM sample has a significant OSC property.

Similar result may be observed for CO. As may be seen, the CO signal in presence of disclosed OSC shown in curve 108 does not reach the CO signal of empty reactor shown in curve 104. This result indicates the consumption of a significant amount of CO by the disclosed OSM sample and desorption of stored O₂ for the conversion of CO to CO₂. The measured CO delay time, which is the time required to reach to a CO concentration of 4000 ppm in the presence of OSM sample is about 61.34 seconds. The CO delay time measured from OSC isothermal oscillating test 100 shows that the disclosed OSM sample has a significant OSC property.

The measured O₂ delay time and CO delay times may be an indication that the disclosed OSM, substantially free from PGM and without the presence of RE metals, may exhibit enhanced OSC as noted by the highly activated total and reversible oxygen adsorption and CO conversion that occurs under isothermal oscillating condition.

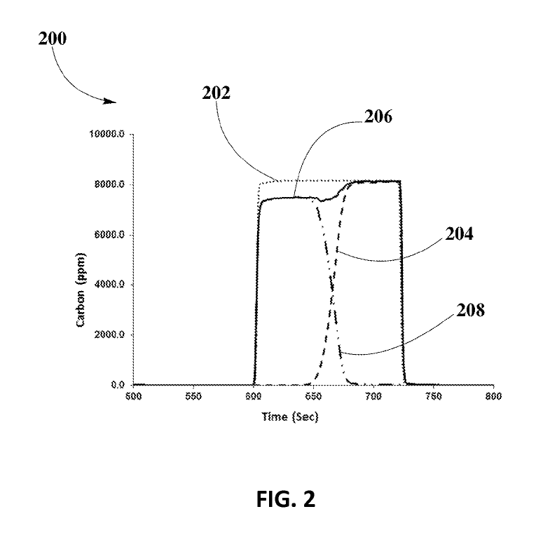

According to an embodiment of the present disclosure, FIG. 2 depicts a graph of carbon balance 200 which may be obtained during OSC isothermal oscillating test of the fresh sample of OSM, described in FIG. 1. Carbon balance 200 may illustrate what occurs during flowing of CO on the OSM sample and desorption of stored O₂ for the conversion of CO to CO₂.

As may be seen in FIG. 2, curve 202 (dot graph) shows the concentration of carbon element in the empty test reactor during flowing of the CO feed and curve 206 (solid line graph) shows the concentration of carbon element in the OSM sample in the test reactor during flowing of the CO feed. The gap observed in the elemental balance shows adsorption of part of the CO flowing in the OSM sample. Additionally, curve 204 (dashed graph) depicts the concentration of CO passing through fresh sample of the disclosed OSM in reactor and curve 208 (double dot dashed graph) shows the concentration CO₂ formed in the reactor including fresh sample of the disclosed OSM in reactor.

As may be observed in FIG. 2, the formation of CO₂ (curve 208) indicates oxidation of CO and desorption of stored O₂ during flowing of the CO feed. The O₂ required for formation of CO₂ is supplied by the O₂ already stored in the disclosed OSM sample. The storage of O₂ under lean condition, when the O₂ feed is flowing, and releasing of O₂ under rich condition, when the CO feed is flowing, confirm the OSC property of disclosed OSM sample.

OSC Property of an Aged OSM Sample

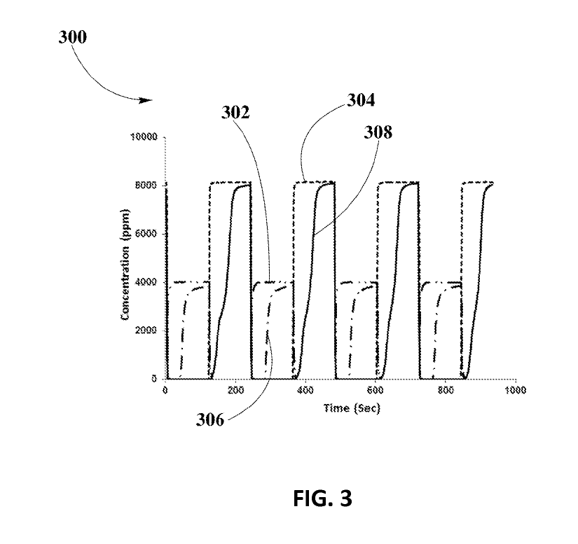

FIG. 3 shows OSC isothermal oscillating test 300 for an aged sample of OSM at temperature of about 575° C., according to an embodiment. In FIG. 3, curve 302 (double-dot dashed graph) shows the result of flowing 4,000 ppm O₂ through the empty test reactor; curve 304 (dashed graph) depicts the result of flowing 8,000 ppm CO through the empty test reactor; curve 306 (single-dot dashed graph) shows the result of flowing 4,000 ppm O₂ through the test reactor including the disclosed OSM; and curve 308 (solid line graph) depicts the result of flowing 8,000 ppm CO through the test reactor including the disclosed OSM.

OSC Isothermal oscillating test 300 may be performed in the test reactor using SV of 60,000 hr-1, ramping from room temperature to isothermal temperature of about 575° C. under dry N₂. Repeated switching from flowing O₂ and flowing CO may be enabled every 2 minutes for a total time of about 1,000 seconds. The aged sample of OSM in the present embodiment may be hydrothermally aged employing 10% steam/air at about 900° C. for about 4 hours.

As may be seen in FIG. 3, the gap between curve 302 and curve 306 may indicate that there is O₂ storage in the OSM with O₂ delay time of about 45.54 seconds. Similarly, the gap between curve 304 and curve 308 may indicate that there is CO adsorption/consumption by OSM sample. Carbon balance results of the aged sample of the disclosed OSM shows formation or CO₂ at this step where the O₂ required for oxidation is released from the O₂ stored in the aged OSM sample during flowing of the O₂ feed. The CO delay time of about 51.05 seconds was measured for the aged OSM sample. The measured O₂ delay time and CO delay time may be an indication that the disclosed OSM, substantially free from PGM and without the presence of RE metals, may exhibit, after hydrothermal aging, an OSC property that is less than the resulting OSC property obtained for a fresh sample of the disclosed OSM, as noted by the decrease in O₂ and CO delay times. However, the resulting O₂ and CO delay times are indicative of an above satisfactory OSC property and thermal stability of disclosed OSM sample.

OSC Property of a Fresh Sample of PGM Catalyst

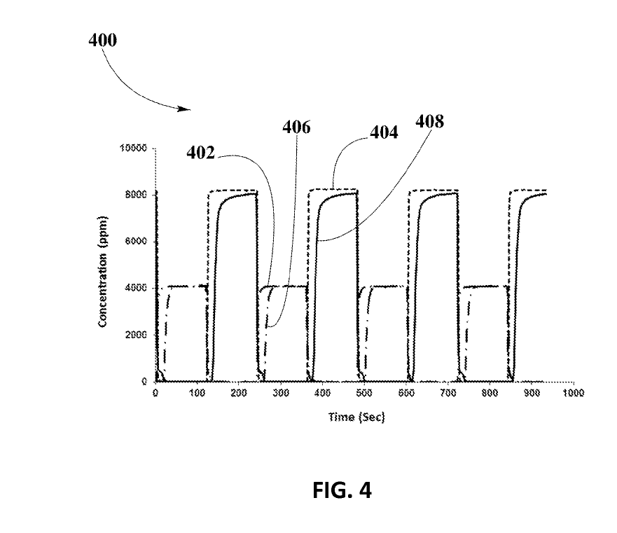

FIG. 4 shows OSC isothermal oscillating test 400 for a fresh sample of a commercial PGM catalyst, according to an embodiment. OSC isothermal oscillating test 400 may be performed in a reactor using SV of 60,000 hr-1, ramping from room temperature to isothermal temperature of about 575° C. under dry N₂. Repeated switching from flowing O₂ and flowing CO may be enabled every 2 minutes for a total time of about 1,000 seconds.

The fresh sample of PGM catalyst may be a palladium (Pd) catalyst including 20 g/ft³ Pd and OSM, using loading of about 60% by weight. The OSM may include several RE metals, mostly CeO₂, with loading of about 30% to about 40% by weight.

Results from OSC isothermal oscillating test 400 may be seen in FIG. 4, where curve 402 (double-dot dashed graph) (double-dot dashed graph) shows the result of flowing 4,000 ppm O₂ through the empty test reactor; curve 404 (dashed graph) depicts the result of flowing 8,000 ppm CO through the empty test reactor; curve 406 (single-dot dashed graph) shows the result of flowing 4,000 ppm O₂ through the test reactor including the PGM catalyst sample; and curve 408 (solid line graph) depicts the result of flowing 8,000 ppm CO through the test reactor including the PGM catalyst sample.

As may be seen in FIG. 4, the gap between curve 402 and curve 406 may indicate that there is O₂ stored by the Ce-based OSM in the PGM catalyst sample with O₂ delay time of about 20.03 seconds. Similarly to FIG. 1 and FIG. 3, a CO delay time for the PGM sample is measured to be about 17.56 seconds. The measured O₂ delay time and CO delay time may be an indication that the fresh sample of Pd-OSM catalyst may exhibit a good level of OSC property, but the measured O₂ and CO delay times are less than the resulting O₂ and CO delay times obtained for the fresh and hydrothermal aged samples of the disclosed OSM, which is substantially free from PGM and without the presence of RE metals, when tested under isothermal oscillating condition.

OSC Property of a Fresh Sample of OSM with Variation of Temperature

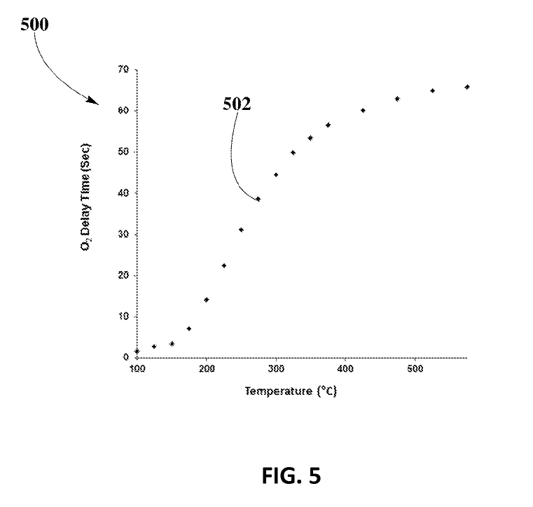

FIG. 5 depicts OSC property 500 of a fresh sample of disclosed OSM with variation of temperature, according to an embodiment.

A plurality of isothermal oscillating tests may be performed for fresh samples of the disclosed OSM using a series of selected temperatures within the range of about 100° C. to about 600° C. As may be observed in FIG. 5, each of the data points 502 represents an isothermal oscillating test performed at a selected temperature from which the corresponding O₂ delay time may be measured.

It may also be additionally observed in FIG. 5 that by increasing the temperature, the OSC property of the disclosed OSM increases. This behavior may be an indication of the enhanced activity and thermal stability of the OSM since the use of OSM may usually be for temperatures above 300° C., for the different reactions that may occur and for the different catalyst applications in which the disclosed OSM may provide optimal OSC. The disclosed OSM may provide optimal OSC, while maintaining or even improving upon the thermal stability and facile nature of the redox function of the used chemical components, without PGM and RE metal components. Moreover, as may be seen in FIG. 5, even at low temperature there is extensive OSC property as depicted by O₂ delay time.

As may be seen in OSC property 500, when the fresh sample of PGM catalyst is compared with a fresh sample of the disclosed OSM, the O₂ delay time for isothermal oscillating condition at about 575° C. for the PGM catalyst is about 20.03 seconds while for the fresh sample of the disclosed OSM, at the same temperature, the O₂ delay time is about 62.99 seconds, indicating a higher level of activity and OSC property of disclosed OSM free of PGM and RE metal. For the fresh sample of the disclosed OSM, as may be seen in FIG. 5, an O₂ delay time of about 20.03 seconds, similar as the O₂ delay time measured for the PGM catalyst sample, may be achieved at very low temperature of about 210° C. Therefore, disclosed OSM has significant higher OSC property than PGM catalyst including Ce-based OSM.

The OSM without PGM and RE metals, prepared from a CuMn₂O₄ stoichiometric spinel deposited on Nb₂O₅—ZrO₂ support oxide, according to the principles in the present disclosure, may be employed in a large number of catalyst applications because of the exhibited optimal OSC property that may surpass the OSC property of PGM catalysts including RE-based OSM. Even after aging samples of the disclosed OSM, the O₂ and CO delay times may be higher than the O₂ and CO delay times of PGM catalysts, showing thermal stability of disclosed OSM.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
a substrate; and
at least one oxygen storage material that is substantially free of platinum group metals;
wherein the at least one oxygen storage material comprises at least one of CuMn₂O₄, Nb₂O₅—ZrO₂, and combinations thereof.

2. The catalyst system of claim 1, wherein the CuMn₂O₄ is in a spinel phase.

3. The catalyst system of claim 1, wherein the Nb₂O₅—ZrO₂ comprises about 15% to about 30% by weight of Nb₂O₅.

4. The catalyst system of claim 1, wherein the Nb₂O₅—ZrO₂ comprises about 25% by weight of Nb₂O₅.

5. The catalyst system of claim 1, wherein the Nb₂O₅—ZrO₂ comprises about 70% to about 85% by weight of ZrO₂.

6. The catalyst system of claim 1, wherein the Nb₂O₅—ZrO₂ comprises about 75% by weight of ZrO₂.

7. The catalyst system of claim 1, wherein the at least one oxygen storage material is deposited on the substrate at about 120 g/L.

8. The catalyst system of claim 2, wherein the Cu—Mn spinel structure comprises about 10 g/L to about 15 g/L of Cu.

9. The catalyst system of claim 2, wherein the Cu—Mn spinel structure comprises about 20 g/L to about 25 g/L of Mn.

10. The catalyst system of claim 1, wherein the Nb₂O₅—ZrO₂ is deposited on the substrate at about 80 g/L to about 90 g/L.

11. The catalyst system of claim 1, wherein the at least one oxygen storage material is substantially free of rare earth metals.

12. The catalyst system of claim 1, where in the O₂ delay time is about 40 seconds at about 300° C.

13. The catalyst system of claim 1, where in the O₂ delay time is about 60 seconds at about 400° C.

14. The catalyst system of claim 1, wherein the at least one oxygen storage material is at least partially aged.

15. The catalyst system of claim 14, wherein the aging is hydrothermal aging.

16. The catalysts system of claim 2, wherein the CuMn₂O₄ is heated to about 600° C.

17. The catalyst system of claim 1, wherein the at least one oxygen storage material is applied to the substrate by co-precipitation.

18. The catalyst system of claim 1, wherein the at least one oxygen storage material is applied to the substrate as a powder.

19. The catalyst system of claim 1, wherein the at least one oxygen storage material stores O₂ at a concentration of about 2,000 ppm.

20. The catalyst system of claim 1, wherein the at least one oxygen storage material stores CO at a concentration of about 4,000 ppm.
